(19) United States
(12) Patent Application Publication
(10) Pub. No.: US 2023/0026848 A1
(43) Pub. Date: Jan. 26, 2023

(54) APPARATUS AND METHOD FOR CONTROLLING HYDRAULIC ACTUATORS

(71) Applicant: DANFOSS SCOTLAND LIMITED, Edinburgh (GB)

(72) Inventors: Jill MacPherson, Edinburgh (GB); Matthew Green, Edinburgh (GB); Daniel Abrahams, Edinburgh (GB)

(21) Appl. No.: 17/870,653

(22) Filed: Jul. 21, 2022

(30) Foreign Application Priority Data
Jul. 26, 2021 (EP) 21187814.5

(51) Int. Cl. E02F 9/22

(52) U.S. Cl. CPC E02F 9/2296; E02F 9/2267; E02F 9/2232; E02F 9/2292

(57) ABSTRACT

A hydraulic apparatus comprises first and second manifolds each of which is connected to a plurality of actuators via corresponding actuator valves connected in parallel and operated responsive to inputs to regulate the flow of fluid to the actuators. A plurality of working chambers are connectable to either the first or second manifold and have a net flow which is controlled responsive to a negative feedback signal. The negative feedback signal is determined in response to a calculated pressure or flow rate in virtual fluid flow paths extending from the first and second manifolds.

### FIELD OF THE INVENTION

The invention relates to the field of providing pumped flows of hydraulic fluid to (and in some case receiving hydraulic fluid from) hydraulic actuators in hydraulic machines such as vehicles (for example excavators) or industrial machines (e.g. injection moulding machines, waterjet cutting machines).

### BACKGROUND TO THE INVENTION

At the present time, it is common for the hydraulic actuators of excavators, particularly tracked excavators, to be controlled by hydraulic systems with manifolds extending through open-centre actuator valves which are moveable by an operator using a manual control interface (e.g. a joystick) to divert hydraulic fluid supplied by a pump into a manifold to flow from the manifold to hydraulic actuators connected to the various valves. Multiple manifolds have their own pumps and valves. The manifolds also include a throttled aperture (control orifice) with an associated pressure sensor. Hydraulic fluid flows out of the control orifice continuously in use, back to the low pressure side and the pressure at the orifice is monitored and the displacement of the pump is regulated to maintain the measured pressure at a predetermined value by a process of negative control. This control process is known in the art as Negacon. An example can be found in US 20160290370 (Doosan).

It is wasteful of energy to have hydraulic fluid continuously lost through the control orifice and it is possible using a highly controllable variable displacement pump to dispense with this requirement. However, the existing Negacon control process is favoured by operators of excavators. It provides a characteristic response of actuators to commands, and useful feedback to operators as to actuator function, for example, they can feel when an actuator is not moving because it has hit an obstacle. This is in part due to the variation of flow rate to the actuator with manifold pressure. Negacon also provides some useful damping of actuator movement.

It is known to provide a hydraulic control arrangement which does not include such an outlet but in which the pump displacement is varied so as to simulate the presence of leakage through an outlet. This provides an operator with the control and feedback which they are used to and prefer.

Such a virtual control arrangement can be applied to a typical hydraulic arrangement having two or more pumps, each of which feeds a separate manifold to which various actuators are connected. However, we have found that such arrangements are unable to optimally drive high capacity actuators which would typically be connected to and receive fluid from both pumps in a standard hydraulic arrangement.

The invention seeks to provide an improved method of controlling actuators connected using at least two manifolds driven by pumps, which remains energy efficient while providing a desirable response to actuator control commands, and in some embodiments while also providing appropriate feedback to users, who are typical human users of manually operable controls, but who may also be machines (e.g. in robotically controlled apparatuses).

### SUMMARY OF THE INVENTION

According to the invention there is provided a hydraulic apparatus comprising:

a controller;

a prime mover;

a hydraulic machine having a rotatable shaft in driven engagement with the prime mover and comprising a plurality of working chambers having a volume which varies cyclically with rotation of the rotatable shaft, the net displacement of a plurality of groups of one or more of the working chambers being independently variable under the control of the controller;

a plurality of hydraulic actuators;

a hydraulic circuit extending between the plurality of working chambers and the plurality of hydraulic actuators;

wherein the hydraulic circuit comprises a first manifold extending between a first said group of one or more working chambers and a first group of one or more actuators, and a first plurality of actuator valves which are controllable to regulate the rate of flow of hydraulic fluid from the first group of one or more working chambers to the first group of one or more actuators, and a second manifold extending between a different second said group of one or more working chambers and a second group of one or more actuators, and a second plurality of actuator valves which are controllable to regulate the flow of hydraulic fluid from the second group of one or more working chambers to the second group of one or more actuators;

and wherein one or more working chambers are switchable between being part of the first group and connected to the first manifold, and being part of the second group and connected to the second manifold, by one or more ganging valves;

wherein the rates of flow of hydraulic fluid into or out of the first and second manifolds from the first and second groups of working chambers are independently variable (i.e. can be controlled independently for each manifold) by independent control of the first and second groups of one or more working chambers under the control of the controller, and wherein the pressure in the first and second manifolds can thereby vary independently;

the first plurality and the second plurality of actuator valves having positions which are controllable responsive to commands to thereby regulate the rate of flow of fluid from the first and second manifolds to the actuators;

wherein the controller independently controls the net displacement of the first and second groups of one or more working chambers to independently vary the rate of flow to or from the first and second manifold respectively, responsive to the commands, to thereby regulate the response of the actuators to the commands.

The invention also extends to method of controlling the hydraulic apparatus, the method comprising controlling the net displacement of the first and second groups of working chambers to independently vary the flow to or from the first and second manifolds (from or two the first and second groups of one or more working chambers respectively) responsive to commands through the interface.

The positions of the first and second plurality of actuator valves which are controlled are typically open cross-sectional areas (of a conduit through which fluid flows). As valves are opened, the respective open cross-sectional areas increase and as they are closed, the respective open cross-sectional areas decrease.

Thus, the response of the actuators to commands is determined by the position of the first and second plurality of actuator valves, the rate of flow of hydraulic fluid into or out of the first and second manifolds respectively and the input pressure to the first and second manifolds respectively. The rate of flow is in turn determined by the net displacement of the first or second group of working chambers respectively, which could be expressed in volumetric terms or, for example, as a fraction of maximum displacement per rotation of the rotatable shaft, which requires to be multiplied by the maximum volume displacement per rotation of the rotatable shaft and the speed of rotation of the rotatable shaft to give a flow rate in volumetric terms. The input pressures can be increased or decreased by displacing more or less fluid than is supplied to (or received from) the actuators.

As well as controlling the net displacement of the first and second groups of one or more working chambers, the controller may also control the positions of the first and second plurality of actuator valves, for example responsive to commands. The first and second plurality of actuator valves may be controlled other than through the controller, for example by way of commands (e.g. pilot pressures) from inputs, such as user operable controls.

Typically, the controller is configured to switch one or more working chambers from between connected to one manifold to being connected to the other manifold (of the first and second manifolds) by operating the one or more ganging valves. The switching of the one or more ganging valves is responsive to demands for fluid flow to the first group of one or more actuators and the second group of one or more actuators respectively. Thus the controller may, for example, switch one or more working chambers from being connected to the first manifold to being connected to the second manifold in response to an increase in the demand for the second group of one or more actuators, or a decrease in the demand for the first group of one or more actuators, or an increase in the ratio of the demand for the second group of one or more actuators to the demand for the first group of one or more actuators. The switching may allow the demand to be more closely met.

The commands are typically received through an interface. The interface may be an electronic interface. The interface may be a mechanical or hydraulic interface. The interface may communicate commands from a user input device, for example one or more joysticks, levers, pedals or other manual user interface devices.

Thus, the response of the actuators to commands depends not only on the position of the actuator valves (e.g. whether they are open or closed or more typically the extent to which they are open) which is determined in response to commands, but also on the flow into the respective manifold, which flow is also determined in response to commands through the interface and by other variables such as pressure.

The pressure dependency enables the response of the actuators to commands to be better controlled in particular by giving the characteristic behaviour, response and/or feel of actuators in other, less energy efficient, hydraulic circuit configurations experienced by the operator, to be emulated.

As the rate of flow into or out of the first or second manifolds is independently variable, the pressure in the first manifold and the pressure in the second manifold are independent. This is advantageous because otherwise there would be a requirement for both groups of actuators to be driven using the same pressure, even when they require very different flow rates, which is less energy efficient.

Typically, the rate of flow to or from the first and second manifolds is controlled to cause the actuators to respond to the received commands, e.g. to seek to meet the commands. The commands may for example indicate a demand for fluid flow or pressure or actuator position. It may be possible for the demands to be met in full. It may be that in some circumstances it is only possible for the demands to be partially met. For example, if the commands could not be met without more fluid flow than is possible, fluid flow to individual actuators may be scaled back, for example proportionately, or by prioritising flow to one or more actuators over flow to one or more further actuators.

The apparatus may comprise one or more first pressure sensors to measure the pressure in the first manifold and one or more second pressures sensors to measure the pressure in the second manifold, typically in the region between the respective working chambers and actuator valves for example where fluid enters or leaves the manifolds from or to the respective groups of working chambers.

Typically, the first manifold (and typically also the second manifold) does not comprise a throttle aperture through which working fluid may flow out of the first (or second) manifold to a low pressure region during normal operation.

This contrasts with common excavator control arrangements in which the manifolds are also each connected to control outlets for pressurised working fluid (e.g. to tank or a low pressure manifold) through a throttle aperture (typically one or more orifices of predetermined cross-section) such that, in use, there can be a flow of hydraulic fluid out of the respective manifold through the throttle aperture (other than via one or more actuators which are thereby actuated).

In such arrangements, the pressure of working fluid in the manifold just before the throttle aperture is typically measured and used to control hydraulic machine (typically pump) displacement using negative feedback. These common excavator control arrangements provide a desirable response of actuators to commands and/or a desirable link between the feel of (movement of or forces exerted by) manual controls to actuator movements, but waste energy due to the leakage of hydraulic fluid out of the manifolds through the throttle apertures in use.

It may be that the first and second groups of one or more actuators do not contain any actuators in common. However, in some embodiments, it may be that one or more actuators are part of the first and second groups of one or more actuators. Typically, the actuators of the first and second groups of one or more actuators are each connected to only a single manifold (the first or second manifold). It may be that each actuator of the apparatus is connected to only a single manifold extending to a group of one or more working chambers.

Typically the controller is configured to control (and the method comprises controlling) the flow to or from the first manifold (and typically also the second manifold) and thereby the flow of hydraulic fluid to or from the actuators through the actuator valves, responsive to a feedback signal calculated based on a (virtual) property in a (virtual) hydraulic circuit extending from the first (or second) manifold and comprising one or more (virtual) valves, the position of which varies in dependence the position of the actuator valves responsive to the commands. The virtual property may be obtained by simulation of properties of the virtual hydraulic circuit, taking into account measured parameters, such as valve or actuator positions and pressures or flow rates in the hydraulic circuit, torque in a rotating shaft etc.

The (virtual) position of the (virtual) valves which varies may be a (virtual) open cross-sectional area which may vary (e.g. linearly) with the open cross-sectional area of the actuator valves. The (virtual) open cross-sectional area of the (virtual) valves may be increased, or may be reduced, when the open cross-sectional area of the actuator valves is increased.

The feedback signal may for example be calculated based on a pressure or flow rate of (virtual) fluid in the (virtual) hydraulic circuit, or the position of a (virtual) actuator, or torque in a (virtual) rotating shaft etc.

Typically, the controller is configured to control (and the method comprises controlling) the flow to or from the first manifold (and typically also the second manifold), responsive to a calculated pressure or flow rate at a control point in a virtual fluid flow path extending from the first (or second) manifold through one or more virtual valves which regulate a virtual fluid flow dependent on the position of the actuator valves.

Typically, the virtual fluid flow path extends through one or more virtual valves and a virtual throttle aperture to a lower pressure region.

Typically the controller is configured to control (and the method comprises controlling) the flow to or from the first manifold (and typically also the second manifold) responsive to a calculated pressure or flow rate at a control point in each of a plurality of virtual fluid flow paths extending from the first (or second) manifold through one or more different virtual valves which divert virtual fluid flow dependent on the position of respective actuator valves to respective throttle apertures to a lower pressure region.

It may be that the flow to or from the first manifold (and typically also the second manifold) is controlled such that the inlet pressure of the first manifold (and typically also the second manifold) is varied responsive to a calculated pressure or flow rate at a control point in a virtual fluid flow path, or at controls points in each of a plurality of virtual fluid flow paths.

By the inlet pressure of the first (or second) manifold we refer to the pressure of fluid where fluid flow into (or out of) the first (or second) manifold from the first (or second) group of one or more working chambers.

It may be that the first plurality of actuator valves are connected in parallel to the first manifold. The first group of one or more actuators may be connected in parallel to the first manifold through respective actuator valves. It may be that the second plurality of actuator valves are connected in parallel to the first manifold. The second group of one or more actuators may be connected in parallel to the second manifold through respective actuator valves.

It may be that two or more virtual valves are treated as if they are connected in series in a virtual fluid flow path whereas the corresponding actuator valves are connected to the first (or second) manifold in parallel.

By the corresponding virtual and actuator valves we refer to the virtual and actuator valves that are both controlled by the same control input, typically an operator joystick command. The position of the actuator valve determines the cross-sectional area, also called the orifice area, through which actual fluid can flow, whereas the virtual position of the virtual valve determines a virtual cross-sectional area through which a virtual flow will occur, in dependence on the pressure condition upstream and downstream of the virtual valve.

It may be that there are a plurality of said (virtual) flow paths extending in parallel from the first (and typically also second) manifold, having a different one or more (virtual) control valves therein and where a calculated pressure or flow rate in each of the said plurality of flow paths is taken into account in determining the flow rate into the first manifold (or second manifold respectively) from the first group (or second group respectively) of working chambers.

It may be that in one of the said plurality of flow paths extending in parallel from the first (and typically also second manifold) there are a plurality of control valves connected in series and in another one of the said plurality of flow paths extending in parallel from the first (and typically also second manifold) there is a single control valve. It may be that for at least one actuator, both of the said plurality of flow paths comprise a control valve the orifice area of which is determined based on the same actuator control signal.

It may be that the interface provides an output which varies responsive to the input pressure in the first and/or second manifold.

The output may be a variation in the response of a manually operated control, such as a lever, button or wheel. The variation in response with pressure may be one or more of (i) movement of the manually operated control, (ii) resistance to movement of the manually operated control, (iii) a force exerted by the manually operated control, (iv) a variation in resistance to movement or exerted force of the manually operated control with movement. These responses to pressure in the first and/or second manifolds are useful features of known excavator control arrangements as they provide feedback to a human operator, by feel. For example, they would enable the operator to detect that an actuator (e.g. an excavator bucket) is in contact with an obstacle, because the pressure in the manifold connected to the actuator would rise.

The output may be an electronic signal. One or more user operable manual controls may be coupled to one or more actuator valves, for example through a hydraulic or electronic coupling. The one or more actuator valves may be controlled by the controller responsive to commands received through a (typically electronic) interface.

It may be that the first and second groups of one or more actuator valves are of the closed centre type, with no normally open path and a normally closed path to the actuator, each of which is openable responsive to a command through the interface to cause hydraulic fluid to flow to at least one actuator.

This contrasts with common valve arrangements in excavators which use negative pressure feedback from a throttle aperture, which are typically based on open centre (open by default) valves, typically connected in series.

It may be that the controller is configured to control (and the method comprises controlling) the flow to or from the first manifold (and typically also the second manifold) such as to cause the actuators to respond to commands through the interface as if the manifold comprised an open outlet through which working fluid flows in use through a throttle aperture to a low pressure region.

Typically, the said throttle aperture, which is not part of the present invention, is an aperture which is permanently open. In the present invention, neither a said throttle aperture nor an outlet pressure sensor configured to measure the pressure in the manifold adjacent the throttle aperture are present. In the present invention, the flow rate to the first and second manifolds is not controlled responsive to negative feedback of the pressure signal from a said outlet pressure sensor adjacent a said throttle aperture (potentially because the pressure sensor and the throttle aperture do not exist, or perhaps because the path is sealed via a valve (between the throttle aperture and the low pressure region)).

It may be that the apparatus is configured to selectively direct (and the method may comprise selectively directing) (or receive) the majority (greater than 50%) of fluid flow from (or to) the plurality of groups of working chambers (typically at least 75% of fluid flow or at least 90% or 100% of fluid flow) to (or from) a single actuator, which is connected only to the first manifold (and not to the second manifold) through at least one actuator valve, responsive to a command. This happens selectively (and temporarily) in dependence on commands received. This contrasts with known devices in which in order for the majority of fluid flow to be directed to or received from a single actuator, fluid is supplied from both manifolds. It may be that the apparatus is configured such that, if required, one or more groups of working chambers will be switched from being connected to the second manifold to being connected to the first manifold responsive to the command to enable this. The method may comprise switching one or more groups of working chambers from being connected to the second manifold to being connected to the first manifold responsive to a command to selectively direct the majority of fluid flow from the plurality of groups of working chamber (for example, more than 50%, or at least 75% or at least 90% or 100% of fluid flow) to or from a single actuator, which is connected only to the first manifold (and not to the second manifold) through at least one actuator valve. It may be that each actuator is connected only to the first or only to the second manifold through actuator valves. It may be that the first group of actuators (and typically also the second) comprise actuators with a plurality of different capacities. It may be that the first group of actuator valves comprise actuator valves which have different maximum open cross-sectional areas.

It may be that the apparatus is configured to selectively connect the majority (greater than 50%), or greater than 75%, or greater than 90% or all of the working chambers of the groups of working chambers to one of the first or second manifold. This occurs selectively (and temporarily) responsive to commands, for example responsive to large demands for fluid flow to or from one or more actuators.

It may be that the apparatus is configured such that the change in pressure in the first manifold varies less for a given change in flow rate to the second actuator than to the first actuator.

It may be that a plurality (which may be some or all) of the first actuator valves are connected in parallel to provide independently controllable parallel paths for fluid flow from the first group of working chambers to actuators.

It may be that the second actuator valves are also connected in parallel.

It may be that the first group of working chambers are controlled to regulate the flow to or from the first manifold such as to cause the rate of fluid flow to a first actuator (of the first one or more actuators) and/or the flow to or from the first manifold, and for the first group to respond as if the first manifold comprised a throttle aperture for hydraulic fluid, which throttle aperture is not in fact present.

Thus, the response of the one or more actuators to commands, and potentially also the feedback provided to a user, varies as if the first manifold had a said throttle aperture. This enables the actuator movements and potentially also feedback of the apparatus to emulate hydraulic control circuits having such a throttle aperture without a requirement to actually have such a throttle aperture, thereby saving energy.

It may be that the controller emulates some or all of the first plurality of open centres being connected in series with each other and through a throttle aperture for hydraulic fluid to a low pressure region and calculates the pressure that would have been at the throttle aperture in order to determine the required displacement of the pump.

It may be that the controller is configured to by default connect (and the method comprises by default connecting) some of the working chambers to the first manifold and some of the working chambers to the second manifold and to connect additional working chambers, to the first manifold when the demand for fluid flow of the first groups of actuators exceeds the maximum rate of fluid flow that can be provided by the group of working chambers at that time.

Thus, the controller may be configured to cause working fluid to be directed to the first and second manifolds to operate actuators connected to the first and second manifolds, such that the first and second manifolds each receive a portion of the net flow of working fluid from the working chambers concurrently. The controller may also be configured to direct working fluid only to one or more actuator which is connected to the first manifold and not to any actuator which is connected to the second manifold and to switch the connection of one or more working chambers from the second manifold to the first manifold.

There may therefore be times when there is a net flow of working fluid from working chambers into the first manifold (for example more than 50% of the maximum rate of flow of working fluid of the hydraulic apparatus) but there is no net flow of working fluid from working chambers into the second manifold.

Typically, the apparatus comprises a plurality of pressure sensors, comprising at least one pressure sensor configured to measure pressure in the first manifold and at least one pressure sensor configured to measure pressure in the second manifold. There may be at least one pressure sensor configured to measure pressure at the input to the first manifold from the first group of working chambers and at least one pressure sensor configured to measure pressure at the input to the second manifold from the second group of working chambers. The controller typically processes the measured pressures from the pressure sensors and also control signals received through the interface to determine at least the displacements of the first and second groups of working chambers.

It may be that the controller independently controls (and the method comprises independently controlling) the displacement of the first and second groups of working chambers, responsive to the commands and, in addition, to implement damping of actuator movement.

It may be that the controller controls (and the method comprising controlling) the net displacement of the first and second groups of working chambers to independently vary the flow in the first and second manifolds responsive to commands through the interface.

Typically, the method typically further comprises switching one or more working chambers from being connected to the first manifold to being connected to the second manifold. In this case, they also swap between the groups of working chambers which are controlled together.

It may be that the flow to or from the first (and typically also the second) manifold is regulated to actively damp oscillations of one or more of the first group of actuators (and typically also of the second group of actuators).

Linear actuators such as excavator booms are often prone to natural oscillation which reduces controllability and could therefore effect efficiency and productivity. A closed loop system can be created which measures said oscillations (using a pressure sensor, position sensor or other) and adjusts the machine flow in order to supress them, by timing the flow adjustment such that the phase of the flow's effect on pressure is opposite to that of the oscillation.

Typically the commands received through the interface are pressures (e.g. pilot pressure) of fluid used to actuate the actuator valves, or they may for example be electronic signals. Typically the actuator valves are normally-closed valves.

The hydraulic circuit may comprise one or more further manifolds, each extending between a respective further said group of one or more working chambers and a further group of one or more actuators, the one or more further manifolds each having a respective further plurality of actuator valves which are controllable to regulate the flow of hydraulic fluid from the respective further group of one or more working chambers to the respective further group of one or more actuators. It may be that one or more or all working chambers are switchable between being connected to the first manifold and being connected to the second manifold and being connected to one of the further manifolds.

However, it may be that the said plurality of working chambers can be connected only to the first or to the second manifold and not to any further manifold.

The hydraulic circuit may comprise one or more fixedly connected working chambers, also having a volume which varies cyclically with rotation of the rotatable shaft, and typically having a net displacement which is independently variable under the control of the controller, which are fixedly connected to one or more further actuators through one or more further manifolds, typically wherein the fixedly connected working chambers cannot be switched between being connected to one manifold and connected to another manifold.

### DESCRIPTION OF THE DRAWINGS

One or more examples of the invention will now be illustrated with reference to the following Figures:

FIG. 1 is a schematic diagram of a known excavator actuator control apparatus;

FIG. 2 is a schematic diagram of a negative feedback control table from the known apparatus of FIG. 1;

FIG. 3 is a schematic diagram of an excavator actuator control arrangement according to the invention;

FIG. 4 is a schematic diagram of a pump module for use with the invention;

FIG. 5 is a schematic diagram of a controller;

FIG. 6 is a schematic diagram of a negative feedback control table for use by apparatus according to the invention;

FIG. 7 is a graph of flow rate (y-axis) versus command signal (x-axis) at different function pressures, according to the invention; and

FIG. 8 corresponds to FIG. 7 but for an apparatus without the feedback calculated according to the invention.

### DETAILED DESCRIPTION OF EXAMPLE EMBODIMENTS

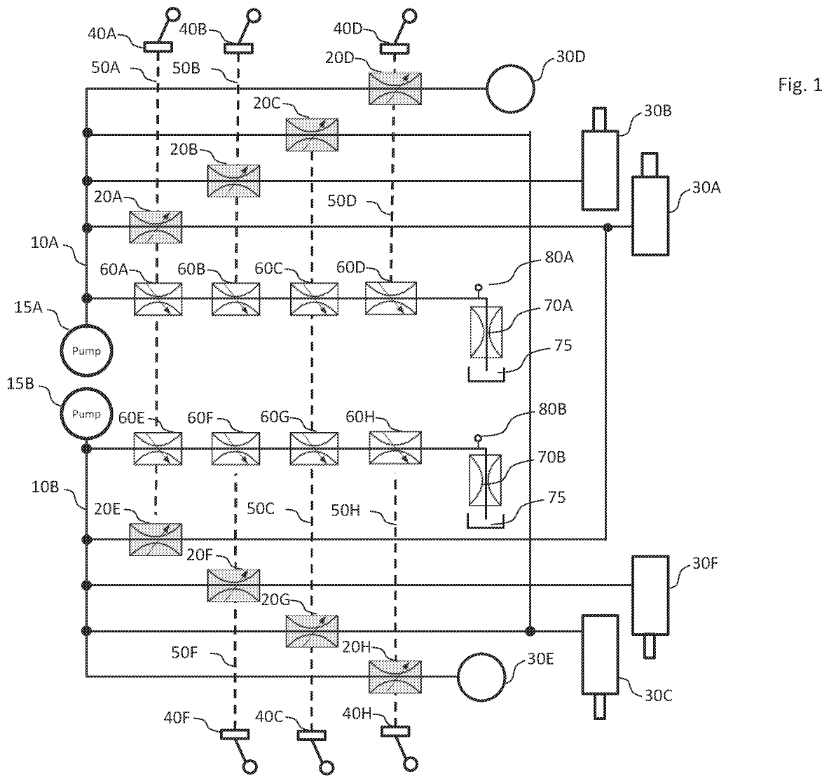

With reference to FIG. 1, a typical hydraulic control system for actuators of a hydraulic excavator employs first and second manifolds 10A, 10B which are arranged to receive hydraulic fluid from variable displacement pumps 15A, 15B respectively. Each manifold extends through a plurality of closed centre actuator control valves 20A, 20B, 20C, 20D, 20E, 20F, 20G, 20H to actuators 30A (a boom), 30B (a bucket), 30C (a dipper function), 30D (right travel), 30E (left travel), 30F (swing function). In this example, the majority of actuators receive fluid from a single manifold via a single individually controllable actuator valve, but two higher capacity actuators (the boom 30A and dipper 30C), receive fluid from both manifolds via respective flow paths each of which has an actuator valve.

A command interface includes manually operated control levers 40A, 40B, 40C, 40D, 40F, 40H, which are used by an operator to control actuators 30A, 30B, 30C, 30D, 30E, 30F. The control levers can be moved to open or close the respective actuator valves through pilot hydraulic control lines 50A, 50B, 50C, 50D, 50F, 50H. As the valves are opened from a closed position, their open cross-sectional area increases from zero, allowing fluid to flow from the respective manifold to the actuator. The rate of fluid flow can be continuously controlled by varying the level position. In some implementations the closed centre valves can be opened in either of two opposite directions, for example to operate an actuator in opposite directions.

The control lines also extend to open centre control valves 60A, 60B, 60C, 60D, 60E, 60F, 60G, 60H. Open centre control valves 60A, 60B, 60C, 60D are connected in series extending from the first manifold 10A to tank (low pressure) 75 via a throttle in the form of an orifice 70A of defined cross-sectional area. Open centre control valves 60E, 60F, 60G, 60H are connected in series extending from the second manifold 10B to tank (low pressure) 75 via a further throttle in the form of an orifice 70B of defined cross-sectional area. Pressure sensors 80A, 80B measure a control pressure on the control valve side of the orifices.

The open centre control valves are open (at a point of maximum open cross-sectional area) when the corresponding actuator valves are closed (point of minimum open cross-sectional area) and they are closed as the actuator valves are opened. For some actuators, the control levers operate a single actuator valve and a corresponding single control valve. For the control levers (40A, 40C) which operate an actuator valve connected to each manifold, the control lines (50A, 50C) extend to the actuator valves and control valves connected to each manifold and regulate these both in concert.

When actuator valves are opened, fluid flows to the respective actuator, with a flow rate determined by how open the actuator valve is (its open cross-sectional area) and the input pressure at the inlet to the respective manifold. In a steady state, the flow rate from the pump supplies fluid at the same rate that it is consumed by actuators.

When no actuator connected to an individual manifold is being operated, a bypass fluid flow can flow from each manifold to tank with minimal flow resistance except for the respective orifice. Accordingly, the control pressure measured at the respective orifice will be virtually the same as the inlet pressure for the same manifold. As actuator valves open, corresponding control valves are closed, increasing flow resistance through the control valves and the control pressures decrease relative to the input pressures.

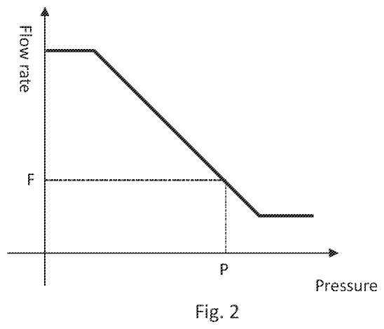

During operation, the control pressures are measured continuously and the displacement of each pump is varied to give a flow rate (F, y-axis) determined in dependence on the measured control pressure (P, x-axis) (control pressure measured by sensor 80A for first manifold 10A and the control pressure measured by sensor 80B for second manifold 10B). FIG. 2 shows the relationship between measured pressure P and flow rate F. This negative feedback arrangement is known in the art as Negacon and produces a distinctive response of actuators to commands.

It should be noted that although the input pressures to the first and second manifolds are neither measured not directly controlled, they are indirectly controlled as a result of the negative feedback control of pump flow rate responsive to the control pressures measured before the orifices 80A and 80B. If fluid in an actuator has a high pressure, or if an actuator cannot move because it faces resistance, the input pressure to the respective manifold will increase because the negative feedback control will cause flow to increase until the input pressure stabilises at a relatively higher value. This is an important part of the feel of known Negacon devices and we have realised that it would be advantageous to replicate this feel.

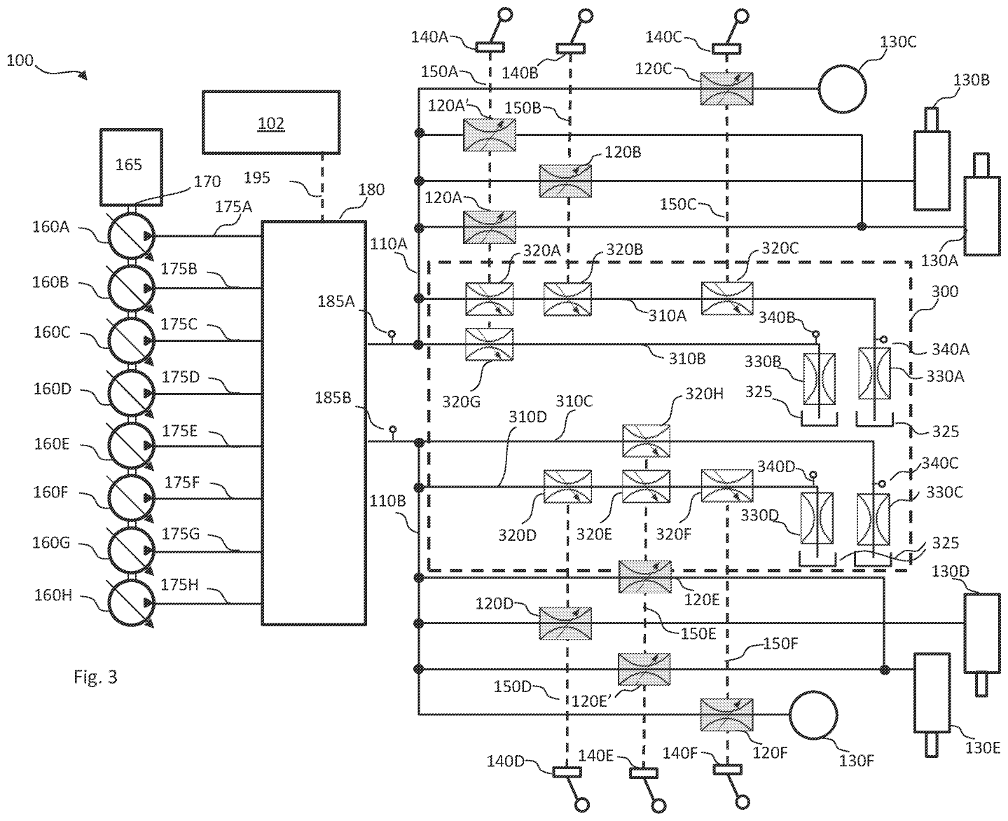

FIG. 3 is a schematic diagram of an arrangement 100 according to the invention. Components within dashed box 300 are not real components but virtual components, the function of which is emulated by the controller 102 as will be described below. As with the arrangement of FIG. 1, there is a first manifold 110A and a second manifold 110B, each of which extends to a plurality of hydraulic actuators, 130A, 130B, 130C, in the case of the first manifold, and 130D, 130E, 130F in the case of the second manifold. The flow to each actuator from the respective manifold is controlled by actuator valves 120A, 120B, 120C, 120A′ in the case of the first manifold and 120D, 120E, 120F, 120E′ in the case of the second manifold. The actuator valves are controlled by control levels 140A, 140B, 140C, 140D, 140E, 140F, one associated with each actuator, by way of pilot pressures in hydraulic control lines 150A, 150B, 150C, 150D, 150E, 150F.

A plurality of pump modules 160A-H are driven by a prime mover 165 via a common rotating shaft 170 and have output manifolds 175A-H which may be switchedly connected to either the first manifold 110A or the second manifold 110B by a valve network 180. The valve network is controlled by the controller 102 through control line 195. The controller also controls the displacement of each individual pump module. Thus, the flow rate to each manifold can be regulated by the controller by controlling the displacement of the individual pump modules and also by controlling which pump modules are grouped together and connected to each manifold. Pressure sensors 185A, 185B measure the input pressure at the first and second manifolds 110A, 110B and transmit their measurements to the controller.

In this example, each actuator is connected to only a single manifold including some actuators which may consume the entire maximum displacement of the pump modules (and would therefore have required connection to both manifolds of the known system of FIG. 1). For these high capacity actuators, two actuator valves connected in parallel provide fluid to a single actuator from the same manifold, controlled by the same control lever, for example actuator valves 120A and 120A′ provide flow to actuator 130A in parallel from the first manifold regulated by control lever 140A and actuator valves 120E, 120E′ provide flow to actuator 130E in parallel from the second manifold regulated by control lever 140E. Nevertheless, rather than using two actuator valves in parallel a single valve with larger cross sectional area for fluid flow could be employed.

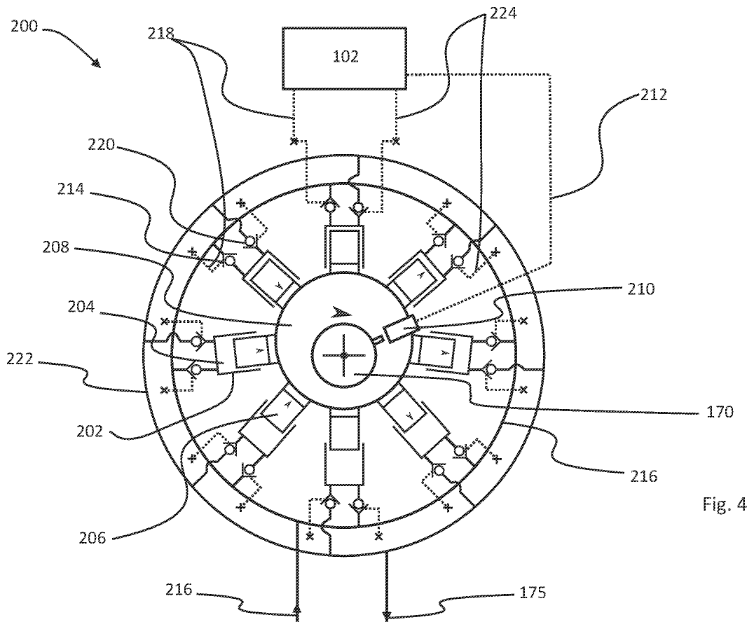

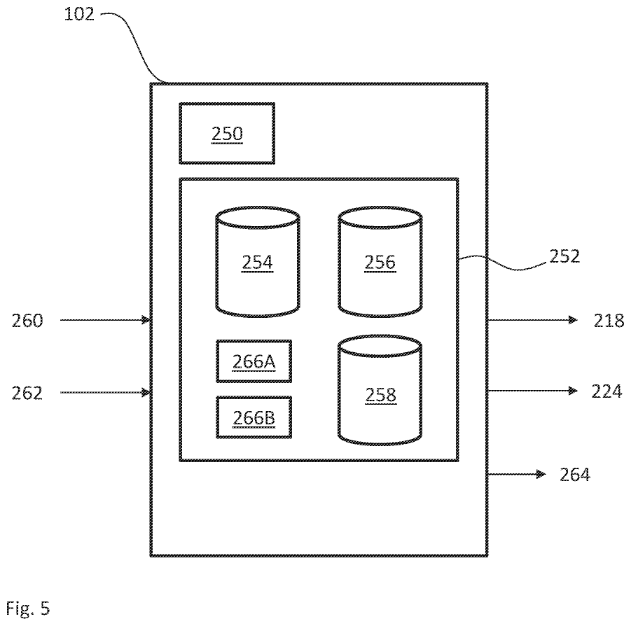

The function of the controller and the pump modules will now be described with reference to FIGS. 4 and 5. FIG. 4 is a schematic diagram of an individual pump module 160 which is useful for the present invention. The pump module is a portion of an electronically commutated hydraulic machine (ECM) 200 implementing a pump module. The ECM comprising a plurality of working chambers having cylinders 202 which have working volumes 204 defined by the interior surfaces of the cylinders and pistons 206 which are driven from a rotatable shaft 170 by an eccentric cam 208 and which reciprocate within the cylinders to cyclically vary the working volume of the cylinders. The rotatable shaft is firmly connected to and rotates with a drive shaft. A shaft position and/or speed sensor 210 determines the instantaneous angular position and/or speed of rotation of the shaft, and transmits this to the controller 102 through signal line 212, which enables the machine controller to determine the instantaneous phase of the cycles of each cylinder.

The working chambers are each associated with Low Pressure Valves (LPVs) in the form of electronically actuated face-sealing poppet valves 214, which have an associated working chamber and are operable to selectively seal off a channel extending from the working chamber to a low-pressure hydraulic fluid manifold 216, which may connect one or several working chambers, or indeed all of the working chambers in the pump module as is shown here, to the low-pressure hydraulic fluid manifold of the apparatus and to tank 75. The LPVs are normally open solenoid actuated valves which open passively when the pressure within the working chamber is less than or equal to the pressure within the low-pressure hydraulic fluid manifold, i.e. during an intake stroke, to bring the working chamber into fluid communication with the low-pressure hydraulic fluid manifold but are selectively closable under the active control of the controller via LPV control lines 218 to bring the working chamber out of fluid communication with the low-pressure hydraulic fluid manifold. The valves may alternatively be normally closed valves.

The working chambers are each further associated with a respective High-Pressure Valve (HPV) 220 each in the form of a pressure actuated delivery valve. The HPVs open outwards from their respective working chambers and are each operable to seal off a respective channel extending from the working chamber to a high-pressure hydraulic fluid manifold 222, which may connect one or several working chambers, or indeed all as is shown in FIG. 2, to the high-pressure hydraulic fluid manifold 175 of the pump module. The HPVs function as normally-closed pressure-opening check valves which open passively due to the pressure difference across the valve, and taking into account the force of a biasing member within the HPV). The HPVs also function as normally-closed solenoid actuated check valves which the controller may selectively hold open via HPV control lines 224 once that HPV is opened by pressure within the associated working chamber. Typically, the HPV is not openable by the controller against pressure in the high-pressure hydraulic fluid manifold. The HPV may additionally be openable under the control of the controller when there is pressure in the high-pressure hydraulic fluid manifold but not in the working chamber, or may be partially openable.

In a pumping mode, the controller selects the net rate of displacement of hydraulic fluid from the working chamber to the high-pressure hydraulic fluid manifold by the hydraulic pump by actively closing one or more of the LPVs typically near the point of maximum volume in the associated working chamber's cycle, closing the path to the low-pressure hydraulic fluid manifold and thereby directing hydraulic fluid out through the associated HPV on the subsequent contraction stroke (but does not actively hold open the HPV). The controller selects the number and sequence of LPV closures and HPV openings to produce a flow or create a shaft torque or power to satisfy a selected net rate of displacement. The above ‘selection’ by the controller is refreshed periodically, or continuously. The selection is refreshed, or updated, when pump modules are moved from being connected to the first manifold to the second manifold, or vice versa.

Some embodiments may include pump modules which are also capable of motoring, thereby regenerating energy from hydraulic fluid received back from the hydraulic actuators, and converting it into mechanical energy, for example when an actuator is lowered or when a wheel motor is operated as a pump in order to apply braking torque. In these cases, the working chambers of the pump modules are also adapted to motor in which case the controller actively controls the HPV as well as the LPV and can carry out a motoring mode of operation in which the controller selects the net rate of displacement of hydraulic fluid, displaced by the hydraulic machine, via the high-pressure hydraulic fluid manifold, actively closing one or more of the LPVs shortly before the point of minimum volume in the associated working chamber's cycle, closing the path to the low-pressure hydraulic fluid manifold which causes the hydraulic fluid in the working chamber to be compressed by the remainder of the contraction stroke. The associated HPV opens when the pressure across it equalises and a small amount of hydraulic fluid is directed out through the associated HPV, which is held open by the hydraulic machine controller. The controller then actively holds open the associated HPV, typically until near the maximum volume in the associated working chamber's cycle, admitting hydraulic fluid from the high-pressure hydraulic fluid manifold to the working chamber and applying a torque to the rotatable shaft.

As well as determining whether or not to close or hold open the LPVs on a cycle by cycle basis, the controller is operable to vary the precise phasing of the closure of the HPVs with respect to the varying working chamber volume and thereby to select the net rate of displacement of hydraulic fluid from the high-pressure to the low-pressure hydraulic fluid manifold or vice versa.

Arrows on the manifolds 216, 175 indicate hydraulic fluid flow in the pumping mode; in the motoring mode the flow is reversed.

In practice there are a number of pump modules such as that shown in FIG. 4, connected by a common shaft and a single controller, and typically using a single shaft position sensor, that can transmit the control signals to the valves associated with each working chamber of each of the pump modules. The working chambers within a pump module need not be evenly spaced around the shaft and are typically interleaved with each other to distribute load along the shaft.

Thus, although the working chambers which make up each pump module are fixed, the pump modules which provide flow to the first and second manifolds can be varied as required.

In some embodiments, in addition to the working chambers, manifolds and actuators which are shown, there will be one or more further pump modules (comprising one or more working chambers) coupled to the common shaft which supply fluid to (or receive fluid from) one or more further actuators through fixed connections. This kind of fixed service is useful for certain types of actuator, e.g. steering actuators.

FIG. 5 is a schematic diagram of the controller 102. The controller includes a processor circuit 250 in electronic communication with memory 252 which stores a database 254 of pump modules and which working chambers are fixedly associated with which pump modules, a database 256 of which pump modules are currently connected to which manifold, and data 258 concerning parameters of simulated hydraulic fluid circuit 200. The controller receives pressure and any other relevant measurement signals 260 for each of the first and second hydraulic circuit manifold and also the shaft position and/or speed signal through signal line 262. The feedback signals 260 could be simple pressure signals, however it may also receive actuator position signals, flow measurements, temperature measurements, commands, for example operator commands, displacement demand signals etc. Output from the controller includes working chamber valve control lines 218, 224 (for controlling LPVs and, if required, HPVs) and valve switching control lines 264 which control valves within the switching block.

In some embodiments, rather than actuator valve commands being communicated independently of the controller, the controller receives commands, e.g. from an electronic interface or user input peripherals, and controls the actuator valves.

During operation, the controller maintains the database of which pump modules are connected to which manifold, starting from a default configuration. The controller also maintains accumulators (which are internal variables stored in the controller) 266A, 266B of the difference between demanded volume of hydraulic fluid and delivered volume of hydraulic fluid to each manifold by pump modules connected to the respective manifold. As the rotatable shaft turns, decision points are reached at different times (shaft positions) for the various working chambers. At the decision point for a given working chamber, the controller determines which hydraulic circuit module the working chamber is connected to (which requires querying the database 254 of pump modules and which working chambers are fixedly associated with which pump modules, and the database 256 of which pump modules are currently connected to which manifold) and the controller then updates the accumulator of the manifold to which the working chamber is connected depending on the received demand for that manifold. The controller then compares the accumulator value with a threshold and if the accumulated demand exceeds the threshold, it schedules then transmits valve controls signals to cause the working chamber to carry out an active cycle in which the working chamber makes a net displacement of working fluid and subtracts the net displacement of working fluid from the value stored by the accumulator. Otherwise, it causes the working chamber to carry out an inactive cycle in which the working chamber makes no net displacement of working fluid (for example, the controller may transmit a signal to the LPV of the working chamber to hold the LPV open throughout a cycle of working chamber volume) and the accumulator is not modified. In this way, the controller makes decisions for each working chamber as to whether or not to carry out active cycles depending on the demand from the manifold to which the working chamber is connected. The accumulators and demand signals may use any convenient units. In one known example, the demand is expressed as “displacement fraction” which is a fraction of the maximum possible displacement per revolution of the rotating shaft, referred to as F_{d}. Target flow rate, in volumetric terms, is a product of F_{d} and the speed of rotation of the rotatable shaft.

From time to time, the controller will determine that there is a requirement to reallocate a pump module from one hydraulic circuit module to another hydraulic circuit module in order to meet changing demand for hydraulic fluid. In this case, the controller transmits a control signal to the relevant valves in the valve network 180 to switch the high pressure manifold of the pump module from one manifold to the other and it updates the database 256 of which pump modules are currently connected to which hydraulic circuit modules. Thus, in future, when a decision point is reached for each working chamber of the pump module which has been switched from allocation to one manifold to another manifold, the controller reads the value of the displacement accumulator of the new manifold and thus the demand for hydraulic fluid by the new manifold.

Referring again to FIG. 3, during operation the actuator valves are opened and closed responsive to user commands as before to regulate the connection of the first and second manifolds to the various actuators. However, the displacement of each pump module is determined using a feedback signal relating to the manifold to which each pump module is connected and calculated based on a virtual fluid pressure in the calculated response of the virtual hydraulic circuit 300.

The virtual hydraulic circuit comprises a first virtual circuit branch 310A extending from first manifold 100A through virtual control valves 320A, 320B, 320C in series to a low pressure sink 325 via a throttle orifice 330A. A second virtual circuit branch 310B extends from first manifold 110A, in parallel with the first virtual branch 310A, through virtual control valve 320G to a low pressure sink 325 via a throttle orifice 330B. Correspondingly, a third virtual circuit branch 310C extends from second manifold 110B, through virtual control valve 320H to a low pressure sink 325 via throttle orifice 330C and, in parallel, fourth virtual circuit branch 310D extends from second manifold 110B, through virtual control valves 320E, 320G, 320H to a low pressure sink 325 via throttle orifice 330D. High capacity actuators 130A, 130E with dual actuator valves 120A, 120A′ and 120E, 120E′ respectively (or single large capacity actuator valves) have corresponding virtual control valves (320A, 320G and 320E, 320H respectively) in each of the two parallel virtual circuit branches extending from the manifold to which they are connected.

Parameters of the virtual hydraulic circuit 300 are stored 258 in the memory 252 and updated to simulate the function of the hydraulic virtual circuit. The simulation makes use of live measurements of the input pressures in the first and second hydraulic manifolds measured by pressure sensors 185A and 185B. The virtual control valves are treated as having an open cross-sectional area which is reduced as the open-cross sectional area of a corresponding actuator valve is increased (320A and 320G are treated as more open when 120A and 120A′ are more closed; 320B is treated as more open when 120B is more closed; 320C is treated as more open when 120C is more closed; 320D is treated as more open when 120D is more closed; 320E and H are treated as more open when 120E and 120E′ are more closed; 320F is treated as more open when 120F is more closed). In practice the open cross-sectional area of each virtual control valve can be determined as a parameter of measurements of controls signals from each control lever. In some embodiments, signals from user controls, or from an electronic interface, will be used to both control the actuator valves and to determine the virtual position of the virtual control valves.

Given the input pressure in the first and second hydraulic manifolds and simulated open-cross sectional area of each virtual control valve and virtual throttle orifices 330A, 330B, 330C, 330D, the pressure drop across each virtual valve and thus fluid pressure and flow rates within the hydraulic virtual circuit are calculated. Of particular relevance are the calculated pressures which would exist in the hydraulic virtual circuit, were it real, before the throttled orifices, in each virtual circuit branch, at locations 340A, 340B, 340C, 340D.

In order to make this calculation, the control signals 150A, 150B, 150C, 150D, 150E, 150F for each actuator are monitored. For each virtual control valve 320A, 320B, 320C, 320D, 320E, 320F, 320G, 320H a virtual open cross sectional area is calculated or determined from a look up table based on the corresponding control signal. The virtual open cross sectional area decreases as the open cross sectional area of the corresponding actuator valve, as indicated by the respective control signal, increases.

For each virtual hydraulic circuit branch comprising multiple virtual control valves in series a total equivalent open cross sectional area A_{equiv} is calculated from the virtual open cross sectional area of each individual control valve, A, as:

$${A}_{equiv} = \sum \frac{1}{{A}^{2}}$$

For each virtual hydraulic circuit branch a simulated leakage flow, q, from the respective manifold through the circuit branch is calculated, for example using the following formula where A is the virtual open cross sectional area of a single valve, or A_{equiv} where there are multiple virtual valves, where ΔP is the pressure immediately upstream of the valve minus the pressure immediately downstream of the valve, c is a coefficient (known in the art as the flow coefficient) which can be found by experiment (and is typically around 0.7), and p is the fluid density.

$$q = \frac{A}{c . \sqrt{\frac{2 Δ P}{ρ}}}$$

The calculated pressure before the virtual throttle orifice, 340A, 340B, 340C, 340D can then be calculated from this flow rate, for example using a lookup table, and the resulting pressure is used as a negative feedback signal to select the net flow rate of the groups of working chambers delivering fluid to the respective manifold.

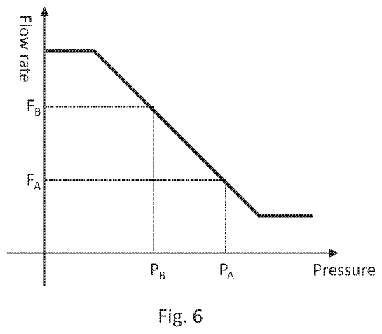

With reference to FIG. 6, flow rates, FA, FB, are determined based on each calculated pressure PA, PB (at 340A and 340B for first manifold 110A; and 340C and 340D for second manifold 110B) for the circuit branches connected to that manifold (310A and 310B for first manifold 110A; and 310C and 310D for second manifold 110B). These are then summed to determine a flow rate, F, for the pump modules connected to the respective manifold.

The displacement of the pump modules connected to the respective manifold is then calculated to give the required flow rate and decisions whether to cause individual cycles of working chamber volume to carry out active or inactive cycles are made accordingly. This may involve calculating a displacement fraction (Fd) corresponding to the required flow rate taking into account the number and capacity of pump modules connected to the respective manifold and the current speed of rotation of the rotatable shaft.

If the displacement demand for one manifold exceeds the maximum possible demand for the working chambers of the pump modules currently connected to that manifold, one or more pump modules are moved from the other manifold by actuation of valves in valve network 180 and the pump module allocations 256 are updated. If it is not possible for the total demand for both manifolds to be delivered at once, the pump modules can be partitioned between the first and second manifolds according to a predetermined prioritisation scheme.

As a result, the flow delivered to each manifold is similar to known Negacon arrangements and the feel of the system to an operator will be similar to that of known Negacon devices. However, there are a number of key differences and benefits:

Firstly, there is no actual loss of working fluid through actual throttle orifices because the manifold branches are virtual, improving energy efficiency.

Furthermore, this has been achieved using relatively few additional sensors. For example some embodiments may measure only manifold input pressures and user commands in order to determine flow rates. Nevertheless, additional sensors may be incorporated, such as additional pressure sensors (e.g. at actuators), actuator position sensors, flow sensors etc.

Pump modules, and their working chambers, can be reallocated from one manifold to the other in order to address variations in the demand for fluid flow to different actuators. Thus, high capacity actuators, potentially requiring more than half of the maximum total output of the pump modules can be supplied from a single manifold as the majority of the pump modules may be connected temporarily to a single manifold when required.

With existing excavators, actuators are allocated to one manifold or another based in part on how often they are used at the same time with a view to reducing the frequency with which two or more actuators on the same manifold are used at once. One reason for this is the energy loss associated with supply fluid to two actuators at different pressure levels from a single pressure source, Actuators with high flow demands may however require to be connected to both manifolds, so that all of the combined pump flow can be routed to them. This in effect combines both manifolds into one. With the present invention, actuators which may be operated at the same time with quite different pressures or flow rates may be allocated to different manifolds. The pump capacity connected to each manifold can be dynamically altered, therefore providing the required flow to any high flow actuators without reducing the system to a single pressure source. This improves energy efficiency.

In the example of FIG. 3, parallel virtual circuit branches 310A and 310B are used to control the flow when high capacity actuator 130A is operated and parallel virtual circuit branches 310C and 310D are used to control the flow when high capacity actuator 130E is operated. The provision of additional virtual circuit branches 310B and 310C and the calculation of pressures at locations 340C, 340C between respective virtual control valves 320G, 320H and throttle orifices 330B, 330C, and the additional actuator control valves (or single higher cross section actuator control valves) enables more than output of more than half of the flow of the pump modules to be used when the respective high capacity actuators are operated, without requiring to connect those actuators to both the first and second manifolds (as per FIG. 1). This is advantageous as the first and second manifolds may remain at different pressures and flow rates when the high capacity actuators are used, saving energy and simplify control and is also enabled by the ability of the machine to move pump modules from being connected from one manifold to the other, to support the delivery of fluid to a high capacity actuator when it is operated.

Advantageously in this example the flow rate and response of the system will always vary with manifold input pressure. Manifold input pressure is an important parameter because it determines the rate of fluid flow into the actuators. Fluid flow into an actuator is at any given time a function of the manifold inlet pressure, the pressure in the actuator and the open cross sectional area of the relevant actuator valve and, as described above, typical Negacon systems do provide this characteristic pressure dependency and so provide a distinctive feel to the control system which is useful to operators. This also provides some smoothing of response. Furthermore, in some configurations the operator can actually feel the pressure in the manifold, for example in terms of resistance to movement of a control joystick. The arrangement according to the invention can advantageously replicate this feel.

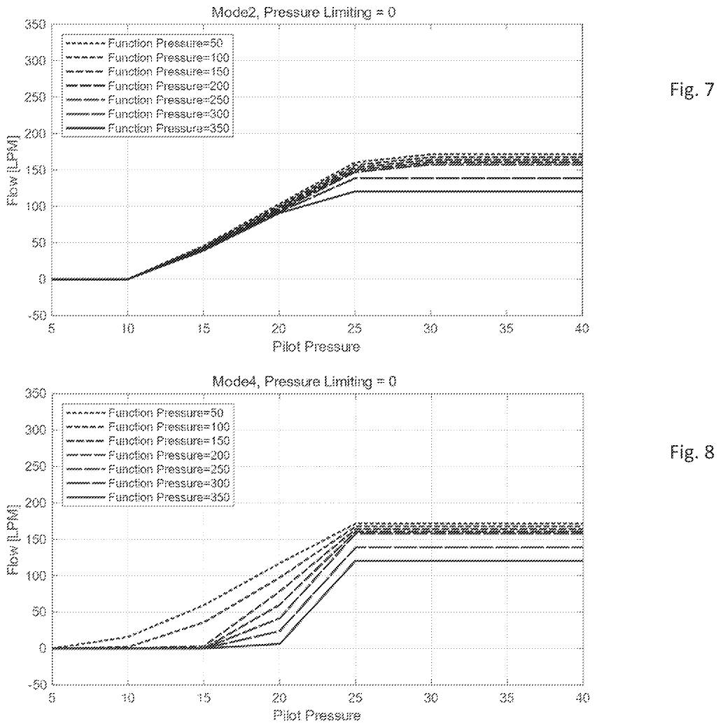

This pressure dependency is shown in FIG. 7 which shows flow rate in litres per minute (y-axis) for different actuator control signal values (x-axis), such as pilot pressures in a hydraulic control line from a joystick, for each of a plurality of different function pressures, being the pressures within an actuator to which fluid is supplied. This contrasts with the corresponding response of a system which corresponds in physical components but which varies pump module flow rate and reallocates pump modules between manifolds using only feedforward of control signals, shown in FIG. 8, without the negative feedback described above.

Furthermore, the high capacity actuators 130A, 130E have a different pressure response to the remaining actuators, due to the additional virtual manifold branch, virtual control valve, virtual control pressure and virtual throttle orifice allocated to each actuator.

Although in this example, pressures within the virtual hydraulic circuit are calculated and used to determine the flow rates of the first and second groups of pump modules by negative feedback, the negative feedback signal may be calculated based on other calculated properties, for example a calculated virtual flow rate or the position or speed of movement of a virtual actuator.

Furthermore, although in the example given the fluid flow rate for each manifold is determined by what is effectively simulation of properties of a virtual hydraulic circuit portion, the controller may calculate the fluid flow rate using alternative algorithms and in any event the calculated feedback signal may be further modified as required, for example it may be filtered to introduce smoothing. The properties of simulated components may be varied, permanently or in different operating modes (e.g. to provide user options), for example virtual control valve open cross-sections may be increased to increase sensitivity to load pressure and decrease the pressure drops in the system, although this has the effect that the respective control joystick will have a larger dead band.

In these examples, the pump modules function as pumps and delivery fluid to the actuators. However, the invention is also operable where the working chambers are controlled as motors which receive fluid from the actuators. The pump modules may therefore be operable pumps and motors in alternative operating modes. This facilitates energy regeneration from hydraulic fluid returned by actuators.

1. A hydraulic apparatus comprising:
a controller;
a prime mover;
a hydraulic machine having a rotatable shaft in driven engagement with the prime mover and comprising a plurality of working chambers having a volume which varies cyclically with rotation of the rotatable shaft, the net displacement of a plurality of groups of one or more of the working chambers being independently variable under the control of the controller;
a plurality of hydraulic actuators; and
a hydraulic circuit extending between the plurality of working chambers and the plurality of hydraulic actuators;
wherein the hydraulic circuit comprises a first manifold extending between a first said group of one or more working chambers and a first group of one or more actuators, and a first plurality of actuator valves which are controllable to regulate the rate of flow of hydraulic fluid from the first group of one or more working chambers to the first group of one or more actuators, and a second manifold extending between a different second said group of one or more working chambers and a second group of one or more actuators, and a second plurality of actuator valves which are controllable to regulate the flow of hydraulic fluid from the second group of one or more working chambers to the second group of one or more actuators,
wherein one or more working chambers are switchable between being part of the first group and connected to the first manifold, and being part of the second group and connected to the second manifold, by one or more ganging valves,
wherein the rates of flow of hydraulic fluid into or out of the first and second manifolds from the first and second groups of working chambers are independently variable by independent control of the first and second groups of one or more working chambers under the control of the controller,
wherein the pressure in the first and second manifolds can thereby vary independently,
the first plurality and the second plurality of actuator valves having positions which are controllable responsive to commands to thereby regulate the rate of flow of fluid from the first and second manifolds to the actuators,
wherein the controller independently controls the net displacement of the first and second groups of one or more working chambers to independently vary the rate of flow to or from the first and second manifold respectively, responsive to the commands, to thereby regulate the response of the actuators to the commands,
wherein the controller is configured to control the flow to or from the first manifold, responsive to a calculated pressure or flow rate at a control point in a virtual fluid flow path extending from the first manifold through one or more virtual valves which regulate a virtual fluid flow dependent on the position of the actuator valves, and
wherein the controller is configured to control the flow to or from the first manifold responsive to a calculated pressure or flow rate at a control point in each of a plurality of virtual fluid flow paths extending from the first manifold through one or more different virtual valves which divert virtual fluid flow dependent on the position of respective actuator valves to respective throttle apertures to a lower pressure region.

2. A hydraulic apparatus according claim 1, wherein the controller is configured to control the flow to or from the first manifold and thereby the flow of hydraulic fluid to or from the actuators through the actuator valves, responsive to a feedback signal calculated based on a virtual property in a virtual hydraulic circuit extending from the first manifold and comprising one or more virtual valves, the position of which varies in dependence on the position of the actuator valves responsive to the commands.

3. A hydraulic apparatus according to claim 2, wherein two or more virtual valves are treated as if they are connected in series in a virtual fluid flow path whereas the corresponding actuator valves are connected to the first manifold in parallel.

4. A hydraulic apparatus according to claim 3, wherein there are a plurality of said virtual flow paths extending in parallel from the first manifold, having a different one or more virtual control valves therein and where a calculated pressure or flow rate in each of the said plurality of flow paths is taken into account in determining the flow rate into the first manifold from the first group of working chambers.

5. A hydraulic apparatus according to claim 1, wherein an interface provides an output which varies responsive to the input pressure in at least one of the first and second manifolds.

6. A hydraulic apparatus according to claim 5, wherein the controller is configured to control the flow to or from the first manifold such as to cause the actuators to respond to commands through the interface as if the manifold comprised an open outlet through which working fluid flows in use through a throttle aperture to a low pressure region.

7. A hydraulic apparatus according to claim 1, configured to selectively direct, or receive, the majority of fluid flow from, or to, the plurality of groups of working chambers to, or from, a single actuator, which is connected only to the first manifold through at least one actuator valve, responsive to a command.

8. A hydraulic apparatus according to claim 7, configured such that the change in pressure in the first manifold varies less for a given change in flow rate to a second actuator than to a first actuator.

9. A hydraulic apparatus according to claim 1, wherein a plurality of the first actuator valves are connected in parallel to provide independently controllable parallel paths for fluid flow from the first group of working chambers to actuators.

10. A hydraulic apparatus according to claim 1, wherein the first group of working chambers are controlled to regulate at least one of the flow to or from the first manifold such as to cause the rate of fluid flow to a first actuator and the flow to or from the first manifold, and for the first group to respond as if the first manifold comprised a throttle aperture for hydraulic fluid, which throttle aperture is not in fact present.

11. A hydraulic apparatus according to claim 1, wherein the controller is configured to by default connect some of the working chambers to the first manifold and some of the working chambers to the second manifold and to connect additional working chambers, to the first manifold when the demand for fluid flow of the first groups of actuators exceeds the maximum rate of fluid flow that can be provided by the group of working chambers at that time.

12. A hydraulic apparatus according to claim 1, wherein the controller independently controls the displacement of the first and second groups of working chambers, responsive to the commands and, in addition, to implement damping of actuator movement.

13. A method of controlling a hydraulic apparatus according to claim 1, the method comprising controlling the net displacement of the first and second groups of working chambers to independently vary the flow to or from the first and second manifolds responsive to commands through the interface.

14. A method according to claim 13, wherein the flow to or from the first manifold is regulated to actively damp oscillations of one or more of the first group of actuators.

15. A hydraulic apparatus comprising:
a controller;
a prime mover;
a hydraulic machine having a rotatable shaft in driven engagement with the prime mover and comprising a plurality of working chambers having a volume which varies cyclically with rotation of the rotatable shaft, the net displacement of a plurality of groups of one or more of the working chambers being independently variable under the control of the controller;
a plurality of hydraulic actuators; and
a hydraulic circuit extending between the plurality of working chambers and the plurality of hydraulic actuators,
wherein the hydraulic circuit comprises a first manifold extending between a first said group of one or more working chambers and a first group of one or more actuators, and a first plurality of actuator valves which are controllable to regulate the rate of flow of hydraulic fluid from the first group of one or more working chambers to the first group of one or more actuators, and a second manifold extending between a different second said group of one or more working chambers and a second group of one or more actuators, and a second plurality of actuator valves which are controllable to regulate the flow of hydraulic fluid from the second group of one or more working chambers to the second group of one or more actuators,
wherein one or more working chambers are switchable between being part of the first group and connected to the first manifold, and being part of the second group and connected to the second manifold, by one or more ganging valves,
wherein the rates of flow of hydraulic fluid into or out of the first and second manifolds from the first and second groups of working chambers are independently variable by independent control of the first and second groups of one or more working chambers under the control of the controller,
wherein the pressure in the first and second manifolds can thereby vary independently,
the first plurality and the second plurality of actuator valves having positions which are controllable responsive to commands to thereby regulate the rate of flow of fluid from the first and second manifolds to the actuators,
wherein the controller independently controls the net displacement of the first and second groups of one or more working chambers to independently vary the rate of flow to or from the first and second manifold respectively, responsive to the commands, to thereby regulate the response of the actuators to the commands,
wherein the controller is configured to control the flow to or from the first manifold, responsive to a calculated pressure or flow rate at a control point in a virtual fluid flow path extending from the first manifold through one or more virtual valves which regulate a virtual fluid flow dependent on the position of the actuator valves, and
wherein two or more virtual valves are treated as if they are connected in series in a virtual fluid flow path whereas the corresponding actuator valves are connected to the first manifold in parallel.

16. A hydraulic apparatus comprising:
a controller;
a prime mover;
a hydraulic machine having a rotatable shaft in driven engagement with the prime mover and comprising a plurality of working chambers having a volume which varies cyclically with rotation of the rotatable shaft, the net displacement of a plurality of groups of one or more of the working chambers being independently variable under the control of the controller;
a plurality of hydraulic actuators; and
a hydraulic circuit extending between the plurality of working chambers and the plurality of hydraulic actuators,
wherein the hydraulic circuit comprises a first manifold extending between a first said group of one or more working chambers and a first group of one or more actuators, and a first plurality of actuator valves which are controllable to regulate the rate of flow of hydraulic fluid from the first group of one or more working chambers to the first group of one or more actuators, and a second manifold extending between a different second said group of one or more working chambers and a second group of one or more actuators, and a second plurality of actuator valves which are controllable to regulate the flow of hydraulic fluid from the second group of one or more working chambers to the second group of one or more actuators,
wherein one or more working chambers are switchable between being part of the first group and connected to the first manifold, and being part of the second group and connected to the second manifold, by one or more ganging valves,
wherein the rates of flow of hydraulic fluid into or out of the first and second manifolds from the first and second groups of working chambers are independently variable by independent control of the first and second groups of one or more working chambers under the control of the controller,
wherein the pressure in the first and second manifolds can thereby vary independently;
the first plurality and the second plurality of actuator valves having positions which are controllable responsive to commands to thereby regulate the rate of flow of fluid from the first and second manifolds to the actuators,
wherein the controller independently controls the net displacement of the first and second groups of one or more working chambers to independently vary the rate of flow to or from the first and second manifold respectively, responsive to the commands, to thereby regulate the response of the actuators to the commands,
wherein the controller is configured to control the flow to or from the first manifold, responsive to a calculated pressure or flow rate at a control point in a virtual fluid flow path extending from the first manifold through one or more virtual valves which regulate a virtual fluid flow dependent on the position of the actuator valves, and
wherein there are a plurality of said virtual flow paths extending in parallel from the first manifold, having a different one or more virtual control valves therein and where a calculated pressure or flow rate in each of the said plurality of flow paths is taken into account in determining the flow rate into the first manifold from the first group of working chambers.
